(19) United States
(12) Patent Application Publication
(10) Pub. No.: US 2011/0258862 A1
(43) Pub. Date: Oct. 27, 2011

(54) Slide Hammer Root Chopper

(75) Inventors: James D. Oberg, Eagle Bend, MN (US); Robert H. Lusty, Alexandria, MN (US)

(73) Assignee: BAC INDUSTRIES, INC., Minnetonka, MN (US)

(21) Appl. No.: 13/094,076

(22) Filed: Apr. 26, 2011

Related U.S. Application Data
(60) Provisional application No. 61/327,777, filed on Apr. 26, 2010.

(51) Int. Cl. B26B 3/00

(52) U.S. Cl. 30/315

(57) ABSTRACT

Embodiments of the present invention disclose a wide V-shaped blade edge at an end of an elongated rod over which is positioned an outer tubular member which can be raised and forcefully lowered to strike an upper end of the inner tubular rod. This landscaping tool allows for removing the root ball of small trees, bushes and shrubs.

### REFERENCE TO RELATED APPLICATIONS

This application is based upon and claims priority to the filing date of provisional application, Ser. No. 61/327,777, filed Apr. 26, 2010, the contents of which are hereby incorporated by reference.

### BACKGROUND OF THE INVENTION

1. Field of the Invention

The present invention relates generally to hand tools for use in landscape maintenance, and more particularly to a slide hammer especially adapted for use in cutting through roots to facilitate removal of shrubs and small trees from the ground.

2. Discussion of the Prior Art

When a shrub, bush or small tree dies or otherwise becomes unsightly, to remove and replace it requires considerable effort, especially if the plant is somewhat mature with an established root system. Grubbing the plant out with a shovel is often difficult. The task can be simplified if the roots of the plant can be cut through to thereby reduce the size of the root ball to be extracted. The blade of a shovel is not a particularly effective root cutting implement and a hatchet or ax is not particular useful when the force of the blow is absorbed by compacted earth surrounding the roots to be cut.

Tree stumps can be very difficult to remove from the ground. They can be shredded with a stump grinder but such machines are relatively expensive and not the type of machine that a homeowner would own and have available.

Another common method for stump removal is to use one of the many chemical stump removal products available on the market. These stump removal products principally comprise potassium nitrate (KNO₃) which accelerates the decay of the stump. It typically takes 4-6 weeks before the stump is sufficiently decayed that it can be fragmented into manageable pieces.

Thus there is a need for a more effective and efficient way of removing shrubs, bushes and small trees, roots and all. It is also deemed desirable to have a landscaping tool capable of slicing through roots buried in the ground that is sufficiently inexpensive so as to be well within the budget of most homeowners. Further, the tools should be such that it does not unduly tear up the surrounding landscape.

### SUMMARY OF THE INVENTION

The root chopper of the present invention comprises a slide hammer in which an elongated, outer metal tubular member of a predetermined length, outer diameter, wall thickness and weight is telescopingly positioned over an elongated inner metal rod whose length is greater than that of the outer tubular member, the metal rod having an outer diameter sized to slidingly fit through an open end of the outer metal tube and allowing a closed end of the outer metal tube to cooperate with a fixed end of the metal rod. Welded to the other end of the metal rod is a blade support to which a cutting blade member is removably affixed. The cutting blade comprises a generally rectangular metal plate having a V-notch formed inwardly from a lower side thereof where the V-notch is defined by tapered and grooved edge surfaces.

In use, the cutting blade is positioned over a root to be severed and by reciprocally raising and forcefully lowering the outer metal tubular member relative to the elongated inner metal rod, a substantial impact force is applied to the cutting blade and thereby forcing the blade through the root.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a perspective view of the slide hammer root chopper; and

FIG. 2 is a side view thereof.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

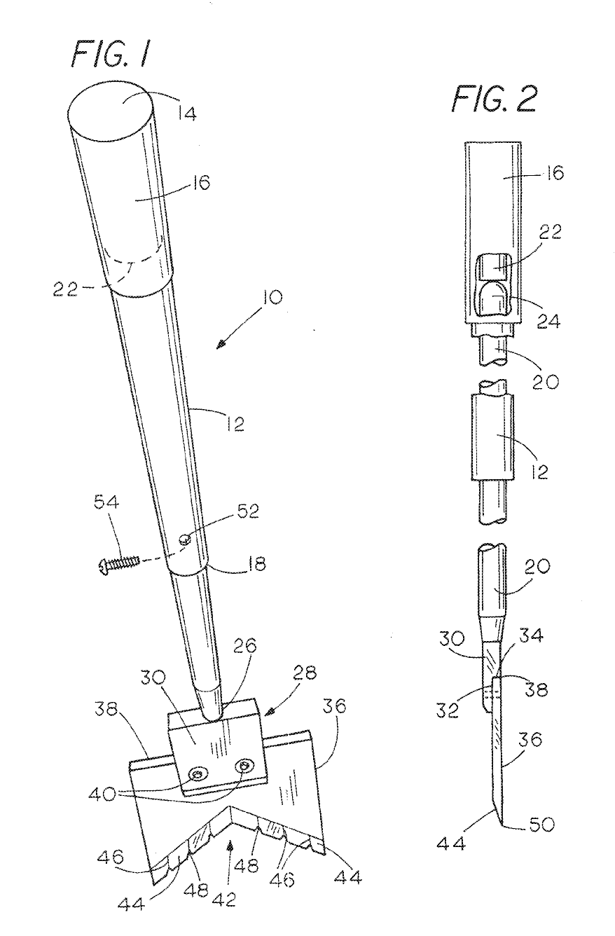

Referring first to FIG. 1, a slide hammer root chopper is indicated generally by numeral 10 and is seen to include an elongated outer metal tubular member 12, preferably of cold rolled steel. Without limitation, the outer tubular member 12 may be about 26-28 inches in length with an outer diameter of 1⅜^{th} inch and an inner diameter of 1⅛^{th} inch. A tubular pipe of this dimension will typically weigh somewhere around six to ten pounds with about eight pounds being preferred.

The outer tubular member 12 has a closed upper end 14 and surrounding the wall thereof is a handgrip 16 which preferably comprises an elastomeric material having a co-efficient of friction to inhibit slipping of a user's grip relative to the tubular member 12.

The lower end 18 of the outer tubular metal member 12 is open to receive therethrough an elongated, inner metal rod 20 whose outer diameter is sized to slidingly fit through the open end 18 of the outer metal tubular member 12. Again, without limitation the inner metal rod may be approximately 1 inch in diameter and be 30 inches in length.

Referring momentarily to FIG. 2, which shows a partial side view of the slide hammer root cutter 10 of FIG. 1, the upper end portion of the outer tubular member contains a steel plug 22 adapted to cooperate with the upper rounded end 24 formed on the inner metal rod 20. The steel plug 22 adds weight to the outer tubular member 12 and is made to deliver a hammer blow to the end 24 of the inner metal rod during use of the tool.

Referring back to FIG. 1, welded to the lower end 26 of the inner metal rod 20 is a blade support 28. This blade support comprises a rectangular metal plate 30 which, as shown in FIG. 2, has a recessed surface 32 defining a shoulder 34. Fitted against the recessed surface 32 is a cutting blade 36 which comprises a rectangular steel plate having an upper edge 38 adapted to abut the shoulder 34 of the blade support 30 and is fastened to the blade support 30 by means of socket head bolts 40.

The weight of the inner rod 20 with the blade support and blade of the illustrated embodiment may be designed to be about 7 pounds so that the combined overall weight of the root chopper will be about 15 pounds.

As best seen in FIG. 1, the side of the blade 36 opposite from the upper side 38 includes a V-notch 42 that is defined by tapered edge surfaces 44.

The tapered edges 44 are preferably scored by a series of grooves as at 46 that create slight serrations 48 where the grooves intersect with the sharp tip edge 50 of the tapered surfaces 44 defining the sharpened edges of the blade.

During storage, it is found convenient to secure the metal rod 20 within outer tubular member 12 against movement and, in this regard, a through-hole 52 may be drilled diametrically through both the outer tubular member 12 and the inner steel rod 20 whereby a pin, as at 54, may be inserted.

During use, the pin 54 is removed and the V-notch of the blade is positioned over a root to be cut. The user will then raise and forcibly lower the outer tubular member 12 relative to the inner steel rod 20 so as to cause the steel plug 22 contained within the upper portion of the outer tubular member to slam against the upper end 24 of the inner tubular member 20. This impact force is delivered to the blade 36 by virtue of its connection to the inner metal rod 20 by the blade support 30. Repeated reciprocal strokes will cause the blade to cut through and sever root structures of smaller trees, shrubs and bushes, thereby facilitating extraction of the tree, bush or shrub from the ground.

The unique design of the blade member 36 with its V-shaped notch 42 allows the blade to easily cut through soil. The grooves 46 and serrations 48 on the sharpened edge of the cutting blade help to prevent bounce-back when a user thrusts the outer tubular member 12 downward against the upper end 24 of the inner rod 20.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A slide hammer root chopper comprising:
(a) an elongated outer metal tubular member of a predetermined length, outer diameter and wall thickness, the outer metal tubular member having a closed upper end and an open lower end;
(b) an elongated inner metal rod of a length greater than the predetermined length of the outer metal tubular member, the metal rod having an outer diameter sized to slidingly fit through the open lower end of the outer metal tubular member and with a first end of the metal rod able to cooperate with the closed upper end of the outer metal tubular member during use; and
(c) a cutting blade member affixed to a second end of the inner metal rod.

2. The slide hammer root chopper of claim 1 wherein the cutting blade member comprises a generally rectangular metal plate having a V-notch formed inwardly from a lower side thereof, the V-notch defined by tapered and grooved edge surfaces.

3. The slide hammer root chopper of claim 1 and further including a blade support affixed at the second end of the inner metal rod, the cutting blade member being removably attached to the blade support.

4. The slide hammer root chopper of claim 3 wherein the blade support includes a straight shoulder, the cutting blade member being a generally rectangular metal plate having a V-notch formed inwardly from a lower side thereof, the V-notch being defined by tapered and grooved edges, an upper side of the rectangular metal plate abutting said straight shoulder of the blade support.

5. The slide hammer root chopper of claim 4 wherein the cutting blade member is bolted to the blade support.

6. The slide hammer root chopper of claim 1 and further including an elastomeric hand grip surrounding a portion of the outer metal tubular member.

7. The slide hammer root chopper of claim 1 and further including a steel plug extending downward a predetermined distance from the closed upper end of the outer metal tubular member.

8. The slide hammer root chopper of claim 7 having an overall weight of about fifteen pounds.

9. The slide hammer root chopper of claim 7 wherein the outer metal tubular member is adapted to be raised and dropped relative to the first end of the inner metal rod when the inner metal rod is generally vertically positioned, such that the steel plug in the outer metal tube impacts the first end of the inner metal rod.
